(19) United States
(12) Patent Application Publication
(10) Pub. No.: US 2016/0042862 A1
(43) Pub. Date: Feb. 11, 2016

(54) ELECTRONIC COMPONENT

(71) Applicant: MURATA MANUFACTURING CO., LTD., Kyoto (JP)

(72) Inventors: Kaoru TACHIBANA, Nagaokakyo-shi (JP); Hiroki HASHIMOTO, Nagaokakyo-shi (JP)

(73) Assignee: MURATA MANUFACTURING CO., LTD., Kyoto (JP)

(21) Appl. No.: 14/887,455

(22) Filed: Oct. 20, 2015

Related U.S. Application Data
(63) Continuation of application No. PCT/JP2014/062097, filed on May 1, 2014.

(30) Foreign Application Priority Data
May 8, 2013 (JP) 2013-098422

(51) Int. Cl. H01F 27/28

(52) U.S. Cl. CPC H01F 27/2804; H01F 2027/2809

(57) ABSTRACT

An electronic component having; a multilayer body including insulating layers stacked on one another; a spiral coil including coil conductors provided on the insulating layers and a first via-hole conductor piercing through at least one of the insulating layers to connect the coil conductors to each other; a parallel conductor provided on one of the insulating layers; and a second via-hole conductor piercing through at least one of the insulating layers to connect the parallel conductor in parallel to one of the coil conductors provided on the insulating layer different from the insulating layer on which the parallel conductor is provided. A portion of the coil conductor not connected in parallel to the parallel conductor at least partly has a greater width than a portion of the coil conductor connected in parallel to the parallel conductor other than a contact point with the second via-hole conductor.

### CROSS REFERENCE TO RELATED APPLICATIONS

This application claims benefit of priority to Japanese Patent Application No. 2013-098422 filed May 8, 2013, and International Patent Application No. PCT/JP2014/062097 filed May 1, 2014, the entire content of each of which is incorporated herein by reference.

### TECHNICAL FIELD

The present disclosure relates to an electronic component, and more particularly to an electronic component having a multilayer body including insulating layers stacked on one another.

### BACKGROUND

As an example of conventional electronic components, a multilayer chip inductor disclosed in Japanese Patent Laid-Open Publication No. 2001-358016 is known. In the multilayer chip inductor, coil patterns are connected to be formed into a coil having a spiral shape. The spiral coil includes some pairs of coil patterns having an identical shape and connected in parallel. Thereby, in the multilayer chip inductor, the DC resistance value of the coil is reduced.

In the multilayer chip inductor disclosed in Japanese Patent Laid-Open Publication No. 2001-358016, since the coil includes some pairs of coil patterns having an identical shape and connected in parallel, the DC resistance value of the coil can be reduced. However, this structure requires a larger number of insulating layers, thereby increasing the height (dimension in the stacking direction) of the multilayer chip inductor.

### SUMMARY

An object of the present disclosure is to provide an electronic component having a reduced DC resistance value and a reduced height (a reduced dimension in a stacking direction).

An electronic component according to an embodiment of the present disclosure comprises: a multilayer body including a plurality of insulating layers stacked on one another in a stacking direction; a spiral coil including a plurality of coil conductors provided on the insulating layers and a first via-hole conductor piercing through at least one of the insulating layers in the stacking direction to connect the plurality of coil conductors to each other; a parallel conductor provided on one of the insulating layers on which the coil conductors are provided; and a second via-hole conductor piercing through at least one of the insulating layers in the stacking direction to connect the parallel conductor in parallel to one of the coil conductors provided on the insulating layer different from the insulating layer on which the parallel conductor is provided; wherein a portion of the coil conductor not connected in parallel to the parallel conductor at least partly has a greater width than a portion of the coil conductor connected in parallel to the parallel conductor other than a contact point with the second via-hole conductor.

The present disclosure provides an electronic component having a reduced DC resistance value and a reduced height.

### BRIEF DESCRIPTION OF THE DRAWINGS

FIG. 1 is a perspective view of an electronic component according to an embodiment.

FIG. 2 is an exploded perspective view of a multilayer body of the electronic component.

FIG. 3 is a plan view of coil conductors and parallel conductors arranged to overlap one another.

FIG. 4 is a perspective view of a multilayer body of an electronic component according to a comparative example.

FIG. 5 is a perspective view of a multilayer body of an electronic component according to a first modification.

FIG. 6 is a plan view of coil conductors and parallel conductors arranged to overlap one another.

FIG. 7 is a perspective view of a multilayer body of an electronic component according to a second modification.

### DETAILED DESCRIPTION

In the following, electronic components according to preferred embodiments will hereinafter be described.

### Structure of Electronic Component

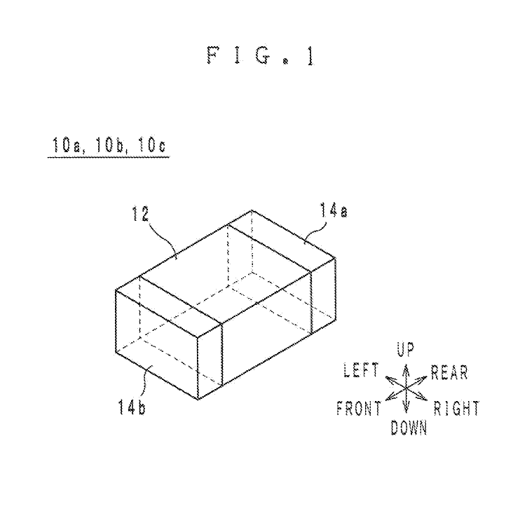

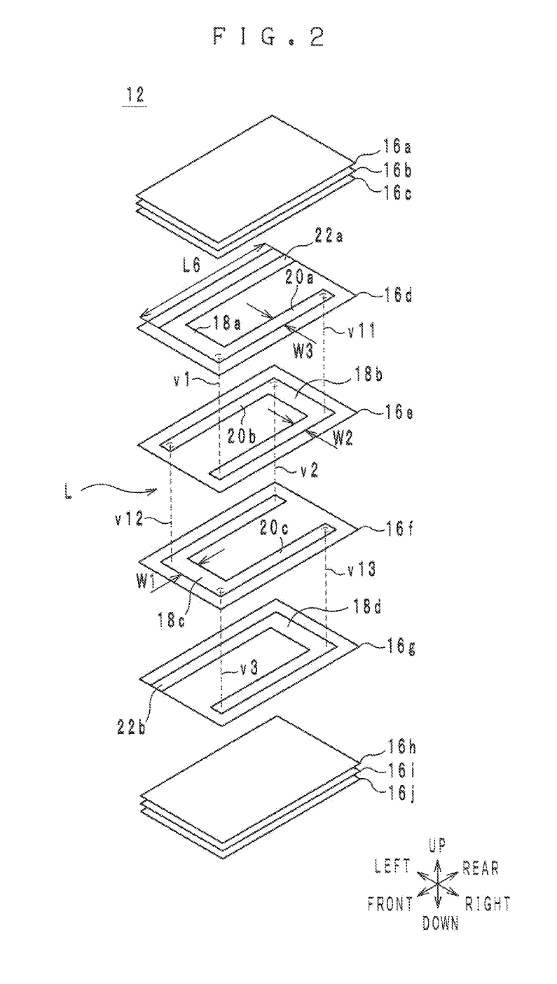

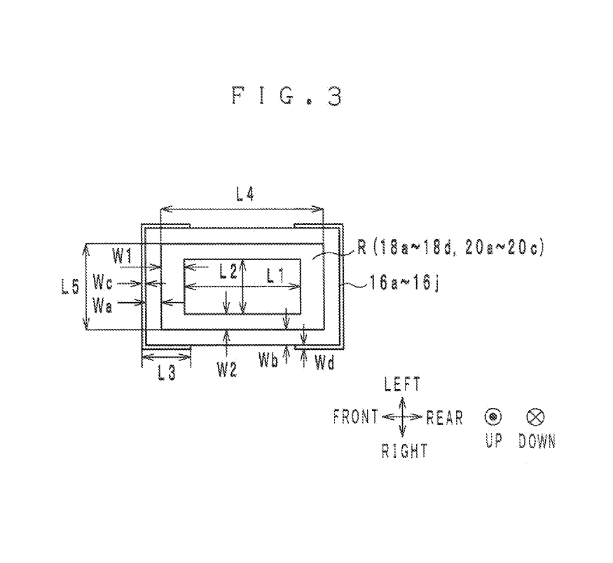

An electronic component according to an embodiment will be described below with reference to the drawings. FIG. 1 is a perspective view of an electronic component 10a according to an embodiment. FIG. 2 is an exploded perspective view of a multilayer body 12 of the electronic component 10a. FIG. 3 is a plan view of coil conductors 18a-18d and parallel conductors 20a-20c arranged to overlap one another. In the following paragraphs, the stacking direction of the electronic component 10a is referred to as an up-down direction. In a plan view of the electronic device 10a from the upside, the direction in which the longer sides of the electronic device 10a extend is referred to as a front-rear direction, and the direction in which the shorter sides of the electronic device 10a extend is referred to as a right-left direction.

As seen in FIGS. 1 and 2, the electronic component 10a comprises a multilayer body 12, external electrodes 14a and 14b, parallel conductors 20a-20c, via-hole conductors v11-v13, and a coil L.

The multilayer body 12 is shaped like a rectangular parallelepiped. The multilayer body 12 includes insulating layers 16a-16j stacked in this order from the upside to the downside. The insulating layers 16a-16j are rectangular as seen in FIG. 2, and the insulating layers 16a-16j are made of a magnetic material, for example, Ni—Cu—Zn-based ferrite. In the following paragraphs, the upper surface of each of the insulating layers 16a-16j is referred to as a front surface, and the lower surface of each of the insulating layers 16a-16j is referred to as a back surface.

The coil L includes coil conductors 18a-18d, lead conductors 22a and 22b, and via-hole conductors v1-v3. The coil conductors 18a-18d, the lead conductors 22a and 22b, and the via-hole conductors v1-v3 are made of a conductive material, for example, an Ag-based material.

The coil conductor 18a is a linear conductor turning counterclockwise on the front surface of the insulating layer 16d. The coil conductor 18a has a length corresponding to a half turn. The coil conductor 18a extends along the left longer side and the front shorter side of the insulating layer 16d.

The coil conductor 18b is a linear conductor turning counterclockwise on the front surface of the insulating layer 16e. The coil conductor 18b has a length corresponding to a half turn. The coil conductor 18b extends along the right longer side and the back shorter side of the insulating layer 16e.

The coil conductor 18c is a linear conductor turning counterclockwise on the front surface of the insulating layer 16f. The coil conductor 18c has a length corresponding to a half turn. The coil conductor 18c extends along the left longer side and the front shorter side of the insulating layer 16f.

The coil conductor 18d is a linear conductor turning counterclockwise on the front surface of the insulating layer 16g. The coil conductor 18d has a length corresponding to a three-quarter turn. The coil conductor 18d extends along the right longer side, the rear shorter side and the left longer side of the insulating layer 16g.

As illustrated in FIG. 3, the coil conductors 18a-18d are arranged to overlap one another to form a rectangular path R in a planar view from the upside. In the following paragraphs, the upstream edge of the counterclockwise turn of each of the coil conductors 18a-18d will be referred to as an upstream edge, and the downstream edge of the counterclockwise turn of each of the coil conductors 18a-18d will be referred to as a downstream edge.

The via-hole conductor v1 pierces through the insulating layer 16d vertically so as to connect the downstream edge of the coil conductor 18a to the upstream edge of the coil conductor 18b. The via-hole conductor v2 pierces through the insulating layer 16e vertically so as to connect the downstream edge of the coil conductor 18b to the upstream edge of the coil conductor 18c. The via-hole conductor v3 pierces through the insulating layer 16f vertically so as to connect the downstream edge of the coil conductor 18c to the upstream edge of the coil conductor 18d. Accordingly, the coil L is formed into a spiral shape extending downward while turning counterclockwise.

The parallel conductor 20a is provided on the front surface of the insulating layer 16d on which the coil conductor 18a is provided. The parallel conductor 20a is a linear conductor extending along the right longer side of the insulating layer 16d. The parallel conductor 20a is connected to the downstream edge of the coil conductor 18a. Thus, the coil conductor 18a and the parallel conductor 20a that are provided on the same surface of the insulating layer 16d are connected to each other. When viewed from the upside, the parallel conductor 20a overlaps the portion of the coil conductor 18b extending along the right longer side of the insulating layer 16e.

The parallel conductor 20b is provided on the front surface of the insulating layer 16e on which the coil conductor 18b is provided. The parallel conductor 20b is a linear conductor extending along the left longer side of the insulating layer 16e. The parallel conductor 20b is connected to the downstream edge of the coil conductor 18b. Thus, the coil conductor 18b and the parallel conductor 20b that are provided on the same surface of the insulating layer 16e are connected to each other. When viewed from the upside, the parallel conductor 20b overlaps the portion of the coil conductor 18c extending along the left longer side of the insulating layer 16f.

The parallel conductor 20c is provided on the front surface of the insulating layer 16f on which the coil conductor 18c is provided. The parallel conductor 20c is a linear conductor extending along the right longer side of the insulating layer 16f. The parallel conductor 20c is connected to the downstream edge of the coil conductor 18c. Thus, the coil conductor 18c and the parallel conductor 20c that are provided on the same surface of the insulating layer 16f are connected to each other. When viewed from the upside, the parallel conductor 20c overlaps the portion of the coil conductor 18d extending along the right longer side of the insulating layer 16g.

The via-hole conductor v11 pierces through the insulating layer 16d vertically so as to connect the rear edge of the parallel conductor 20a to the right rear corner of the coil conductor 18b. Thereby, the parallel conductor 20a is connected in parallel to the coil conductor 18b, which is provided on the front surface of the insulating layer 16e different from the insulating layer 16d on which the parallel conductor 20a is provided, through the via-hole conductors v1 and v11. The parallel conductor 20a is connected in parallel to the portion of the coil conductor 18b forming the right longer side of the path R.

The via-hole conductor v12 pierces through the insulating layer 16d vertically so as to connect the front edge of the parallel conductor 20b to the left front corner of the coil conductor 18c. Thereby, the parallel conductor 20b is connected in parallel to the coil conductor 18c, which is provided on the front surface of the insulating layer 16f different from the insulating layer 16e on which the parallel conductor 20b is provided, through the via-hole conductors v2 and v12. The parallel conductor 20b is connected in parallel to the portion of the coil conductor 18c forming the left longer side of the path R.

The via-hole conductor v13 pierces through the insulating layer 16f vertically so as to connect the rear edge of the parallel conductor 20c to the right rear corner of the coil conductor 18d. Thereby, the parallel conductor 20c is connected in parallel to the coil conductor 18d, which is provided on the front surface of the insulating layer 16g different from the insulating layer 16f on which the parallel conductor 20c is provided, through the via-hole conductors v3 and v13. The parallel conductor 20c is connected in parallel to the portion of the coil conductor 18d forming the right longer side of the path R.

The portions of the coil conductors 18b-18d that are not connected in parallel to any of the parallel conductors 20a-20c have a width W1, and the portions of the coil conductors 18b-18d that are connected in parallel to any of the parallel conductors 20a-20c have a width W2. The width W1 is greater than the width W2. More specifically, the parallel conductor 20a is connected in parallel to the portion of the coil conductor 18b extending along the right longer side of the insulating layer 16e. Therefore, the width W1 of the portion of the coil conductor 18b extending along the rear shorter side of the insulating layer 16e is greater than the width W2 of the portion of the coil conductor 18b extending along the right longer side of the insulating layer 16e. Further, the parallel conductor 20a has a width W3 that is smaller than the width W1 of the portion of the coil conductor 18b extending along the rear shorter side of the insulating layer 16e and equal to the width W2 of the portion of the coil conductor 18b extending along the right longer side of the insulating layer 16e.

The parallel conductor 20b is connected in parallel to the portion of the coil conductor 18c extending along the left longer side of the insulating layer 16f. Therefore, the width W1 of the portion of the coil conductor 18c extending along the front shorter side of the insulating layer 16f is greater than the width W2 of the portion of the coil conductor 18c extending along the left longer side of the insulating layer 16f. Further, the parallel conductor 20b has the width W3 that is smaller than the width W1 of the portion of the coil conductor 18c extending along the front shorter side of the insulating layer 16f and equal to the width W2 of the portion of the coil conductor 18c extending along the left longer side of the insulating layer 16f.

The parallel conductor 20c is connected in parallel to the portion of the coil conductor 18d extending along the right longer side of the insulating layer 16g. Therefore, the width W1 of the portion of the coil conductor 18d extending along the rear shorter side of the insulating layer 16g is greater than the width W2 of the portion of the coil conductor 18d extending along the right longer side of the insulating layer 16g. Further, the parallel conductor 20c has the width W3 that is smaller than the width W1 of the portion of the coil conductor 18d extending along the rear shorter side of the insulating layer 16g and equal to the width W2 of the portion of the coil conductor 18d extending along the right longer side of the insulating layer 16g.

The portion of the coil conductor 18a extending along the front shorter side of the insulating layer 16d has a width equal to the width W1. The portion of the coil conductor 18a extending along the left longer side of the insulating layer 16d has a width equal to the width W2. Thus, as seen in FIG. 3, the widths of the portions of the coil conductors 18a-18d forming the shorter sides of the path R are greater than the widths of the portions of the coil conductors 18a-18d and the parallel conductors 20a-20c forming the longer sides of the path R.

The widths W3 of the parallel conductors 20a-20c need not necessarily be equal to the widths W2 of the portions of the coil conductors 18b-18d that are connected in parallel to any of the parallel conductors 20a-20c.

The lead conductor 22a is provided on the front surface of the insulating layer 16d and is connected to the upstream edge of the coil conductor 18a. The lead conductor 22a leads to the rear shorter side of the insulating layer 16d. The lead conductor 22b is provided on the front surface of the insulating layer 16g and is connected to the downstream edge of the coil conductor 18d. The lead conductor 22b leads to the front shorter side of the insulating layer 16g.

The external electrode 14a covers the rear end surface of the multilayer body 12 and is extended to partly cover the four surfaces adjoining the rear end surface. Accordingly, the external electrode 14a is connected to the lead conductor 22a.

The external electrode 14b covers the front end surface of the multilayer body 12 and is extended to partly cover the four surfaces adjoining the front end surface. Accordingly, the external electrode 14b is connected to the lead conductor 22b.

### Production Method of Electronic Component

A method of producing the electronic component 10a having the structure above will hereinafter be described with reference to the drawings.

First, ceramic green sheets to be used as the insulating layers 16a-16j illustrated in FIG. 2 are prepared. Specifically, ferric oxide (Fe₂O₃), zinc oxide (ZnO), copper oxide (CuO) and nickel oxide (NiO) at a predetermined ratio by weight are put in a ball mill as raw materials and wet-blended. The obtained mixture is dried and crushed, and the obtained powder is calcined at 800 degrees for one hour. The obtained calcined powder is wet-milled in a ball mill, and thereafter, dried and crushed. In this way, a ferrite ceramic powder is obtained.

A binder (vinyl acetate, water-soluble acrylic or the like), a plasticizer, a wetter and a dispersant are added to the ferrite ceramic powder, and these are mixed together in a ball mill. Thereafter, defoaming of the mixture is carried out by decompression. The obtained ceramic slurry is spread on a carrier sheet to be formed into a sheet by a doctor blade method, and the sheet is dried. In this way, ceramic green sheets to be used as the insulating layers 16a-16j are obtained.

Next, in the ceramic green sheets to be used as the insulating layers 16d-16f, the via-hole conductors v1-v3 and v11-v13 are made. Specifically, the ceramic green sheets to be used as the insulating layers 16d-16f are irradiated with laser beams such that via-holes are pierced in the ceramic green sheets. The via-holes are filled with a conductive paste of Ag, Pd, Cu, Au, an alloy of these metals or the like by printing or any other method.

On the ceramic green sheets to be used as the insulating layers 16d-16g, the coil conductors 18a-18d, the parallel conductors 20a-20c and the lead conductors 22a and 22b are formed. Specifically, the coil conductors 18a-18d, the parallel conductors 20a-20c and the lead conductors 22a and 22b are formed by applying a conductive paste consisting mainly of Ag, Pd, Cu, Au, an alloy of these metals or the like on the ceramic green sheets to be used as the insulating layers 16d-16g by screen printing, photolithography or the like. The step of forming the coil conductors 18a-18d, the parallel conductors 20a-20c and the lead conductors 22a and 22b and the step of filling the via-holes with a conductive paste may be executed at the same time.

Next, the ceramic green sheets used as the insulating layers 16a-16j are stacked in this order as illustrated in FIG. 2 and bonded together. Specifically, the ceramic green sheets used as the insulating layers 16a-16j are stacked on top of another and tentatively pressure-bonded together. Thereafter, the tentatively bonded unfired mother multilayer body is subjected to final pressure bonding by isostatic pressing or the like. In this way, an unfired mother multilayer body is obtained.

The mother multilayer body is cut into multilayer bodies 12 having specified dimensions. Thereby, unfired multilayer bodies 12 are obtained. The unfired multilayer bodies 12 are subjected to debinding and firing. The debinding is carried out, for example, at 500 degrees C. in a hypoxic atmosphere for two hours. The firing is carried out, for example, at a temperature of 870 to 900 degrees C. for two hours and a half.

Next, each of the multilayer bodies 12 are chamfered by, for example, barreling. Thereafter, silver electrodes to be used as the external electrodes 14a and 14b are formed by applying a silver-based electrode paste to the surface of the multilayer body 12 by dipping or the like and baking the electrode paste. Baking of the silver electrodes is carried out at 800 degrees C. for one hour.

Finally, the silver electrodes are plated with Ni and Sn, and the external electrodes 14a and 14b are formed. Through the above-described process, the electronic component 10a as illustrated in FIG. 1 is produced.

### Advantageous Effects

The electronic component 10a according to the embodiment has a reduced height (a reduced dimension in the up-down direction). Specifically, the parallel conductors 20a-20c are provided on the insulating layers 16d-16f, respectively, on which the coil conductors 18a-18c are provided respectively. In the electronic component 10a, therefore, it is not necessary to provide additional insulating layers as bases for the parallel conductors 20a-20c. Accordingly, it is not necessary to increase the height (dimension in the up-down direction) of the electronic device 10a.

In the electronic component 10a, the coil L has a reduced DC resistance value. Specifically, in the electronic component 10a, the parallel conductors 20a-20c are connected in parallel to the coil conductors 18b-18d, respectively, through the via-hole conductors v1-v3 and v11-v13 piercing through the insulating layers 16e-16g vertically. Therefore, two current pathways are formed in the portions where the coil conductors 18b-18d are connected in parallel to the parallel conductors 20a-20c, and the DC resistance values in these portions are reduced. The widths W1 of the portions of the coil conductors 18b-18d that are not connected in parallel to any of the parallel conductors 20a-20c are greater than the widths W2 of the portions of the coil conductors 18b-18d that are connected in parallel to any of the parallel conductors 20a-20c. Thereby, the DC resistance values in the portions of the coil conductors 18b-18d that are not connected in parallel to any of the parallel conductors 20a-20c are reduced. Accordingly, the DC resistance value of the coil L can be reduced. As thus far described, in the electronic component 10a, the DC resistance value of the coil L can be reduced, and the height (size in the up-down direction) of the electronic device 10a can be reduced.

In the electronic device 10a, it is possible to reduce a decrease in the inner diameter of the coil L accompanied with the reduction in the DC resistance value of the coil L. Specifically, in an electronic component, a way of reducing the DC resistance value of the coil is, for example, increasing the widths of the coil conductors. However, when the widths of the coil conductors are increased, the inner diameter of the coil will be decreased, and accordingly, the inductance value of the coil will be reduced.

In the electronic device 10a, the widths of the portions of the coil conductors 18a-18d extending along the front and rear shorter sides of the insulating layers 16d-16g are greater than the widths of the portions of the coil conductors 18a-18d extending along the right and left longer sides of the insulating layers 16d-16g. This reduces the decrease in the inner diameter of the coil L and reduces the decrease in the inductance value of the coil L.

Especially in a case in which the axis of the coil L is parallel to the up-down direction and in which the size of the electronic component is small as is the case with the electronic component 10a, if the widths of the portions of the coil conductors 18a-18d extending along the right and left longer sides of the insulating layers 16d-16g are increased in order to ensure a sufficient inductance value of the coil L, the inner diameter of the coil L will be drastically decreased, as compared to when the widths of the portions of the coil conductors 18a-18d extending along the front and rear shorter sides of the insulating layers 16d-16g are increased. Therefore, when it is necessary to increase the widths of the coil conductors 18a-18d, it is preferred that the widths of the portions of the coil conductors 18a-18d extending along the front and rear shorter sides of the insulating layers 16d-16g are increased.

In the electronic component 10a, further, instead of increasing the widths of the portions of the coil conductors 18a-18d extending along the right and left longer sides of the insulating layers 16d-16g, the parallel conductors 20a-20c are connected in parallel to the portions of the coil conductors 18a-18d extending along the right and left longer sides of the insulating layers 16d-16g. Accordingly, both a reduction in the DC resistance value of the coil L and a reduction in the decrease in the inner diameter of the coil L can be achieved.

### Experimental Results

In order to confirm the advantageous effects of the electronic component 10a, the inventors conducted an experiment as will be described below.

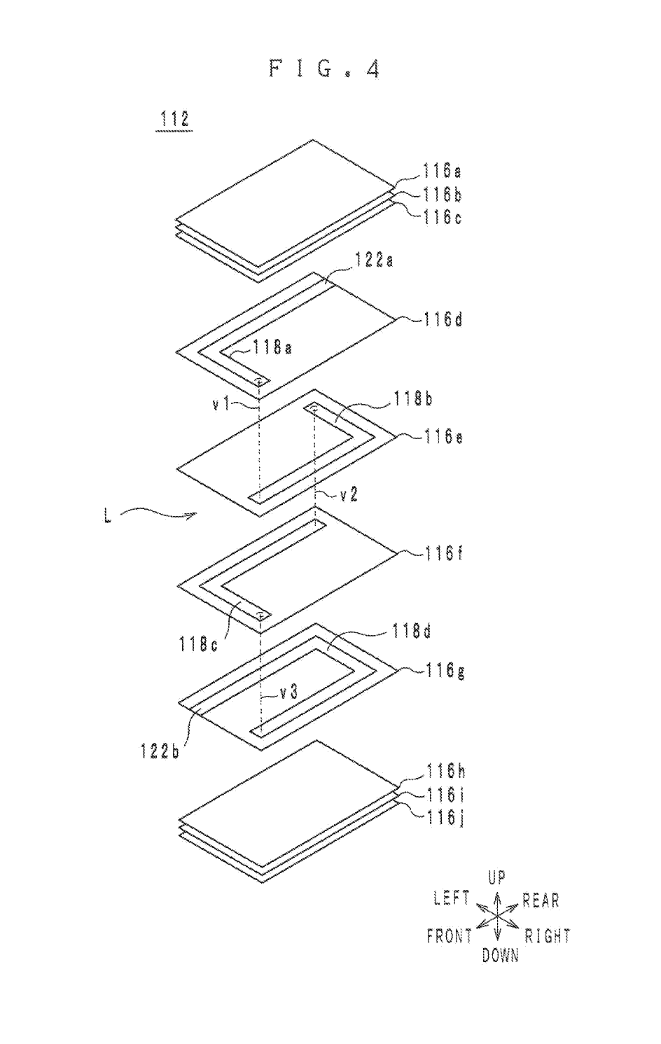

The inventors prepared a sample having the same structure as an electronic component 110 as illustrated in FIG. 4. The sample will hereinafter be referred to as a sample according to a first comparative example. The electronic component 110 is different from the electronic component 10a in that the parallel conductors 20a-20c are not provided and that the widths W1 and W2 of the coil conductors are equal to each other (W1=W2=30 μm). The parts of the electronic component 110 are provided with reference symbols provided for the counterparts of the electronic component 10a plus 100.

The inventors also prepared a sample having a similar structure to the electronic component 110 illustrated in FIG. 4 and specifically having a double spiral structure including coil conductors 118a-118d as illustrated in FIG. 4, two conductors each being connected in parallel to each other by via-hole conductors. This sample will hereinafter be referred to as a sample according to a second comparative example. The inventors also prepared a sample having a similar structure to the electronic component 10a and specifically a structure in which the widths W1 and W2 of the coil conductors are equal to each other (W1=W2=30 μm). This sample will hereinafter be referred to as a sample according to a third comparative example. The inventor also prepared a sample having the same structure as the electronic component 10a and specifically a structure in which the widths W1 of the coil conductors are greater than the widths W2 of the coil conductors (W1>W2, W1=37 μm, W2=28 μm). This sample will hereinafter be referred to as a sample according to a first embodiment. Further, the inventor prepared a sample having a structure in which the widths W1 of the coil conductors are smaller than the widths W2 of the coil conductors (W1<W2, W1=23 μm, W2=32 μm). This sample will hereinafter be referred to as a sample according to a fourth comparative example. In the structures illustrated in FIGS. 2 and 4, the number of turns of the coil L is two and a half. In the samples according to the first comparative example, the third comparative example, the fourth comparative example and the first embodiment, however, three more pairs of coil conductors 18b and 18c (or 118b and 118c) were added so that the number of turns of the coil L would become five and a half. In the sample according to the second comparative example, as will be described later, the number of turns of the coil L was set to seven and a half in order to achieve an inductance value (impedance value) near the inductance value (impedance value) achieved by the first comparative example, the third comparative example, the fourth comparative example and the first embodiment. Also, in the samples according to the first embodiment and the fourth comparative example, the widths of the coil conductors were adjusted in order to achieve an inductance value (impedance value) near the inductance value (impedance value) achieved by the first comparative example through the third comparative example.

Referring to FIGS. 2 and 3, the sizes of various parts of the samples according to the first through fourth comparative examples and the first embodiment are described. The following sizes are common to all of the samples according to the first through fourth comparative examples and the first embodiment.

L1 denotes a dimension in the back-rear direction of the inside of the coil L. L2 denotes a dimension in the right-left direction of the inside of the coil L. L3 denotes a dimension of the portion of each of the external electrodes 14a and 14b extended from the front or rear end surface of the multilayer body 12 or 112 to the adjoining surfaces. L4 denotes a dimension in the front-rear direction of the coil L. L5 denotes a dimension in the right-left direction of the coil L. L6 is a total of the dimension in the front-rear direction of the coil L and the dimension in the front-rear direction of each of the lead conductors 22a and 22b. Wa denotes a distance between the front shorter side of the annular path R and the front end surface of the multilayer body 12 or 112 or a distance between the rear shorter side of the annular path R and the rear end surface of the multilayer body 12 or 112. Wb denotes a distance between the right longer side of the annular path R and the right end surface of the multilayer body 12 or 112 or a distance between the left longer side of the annular path R and the left end surface of the multilayer body 12 or 112. We denotes a thickness of each of the external electrodes 14a and 14b on the front or rear end surface. Wd denotes a thickness of each of the external electrodes 14a and 14b on the right or left end surface. W1 denotes a width of each of the portions of the coil conductors 18a-18d extending along the front and rear shorter sides. W2 denotes a width of each of the portions of the coil conductors 18a-18d extending along the right and left longer sides. T (not indicated in the drawings) denotes the number of turns of the coil L. S (not indicated in the drawings) denotes the square measure of the inside of the coil L.

Table 1 below shows the sizes of various parts of the samples according to the first through fourth comparative examples and the first embodiment. The dimensions L1-L6, Wa-Wd, W1 and W2 are indicated in μm. T is indicated in turns. S is indicated in pmt.

TABLE 1

| | L1 | L2 | L3 | L4 | L5 | L6 |
|---|---|---|---|---|---|---|
| | (μm) | (μm) | (μm) | (μm) | (μm) | (μm) |
| Comparative | 240 | 70 | 100 | 300 | 130 | 335 |
| Example 1 | | | | | | |
| Comparative | 240 | 70 | 100 | 300 | 130 | 335 |
| Example 2 | | | | | | |
| Comparative | 240 | 70 | 100 | 300 | 130 | 335 |
| Example 3 | | | | | | |
| Embodiment 1 | 226 | 74 | 100 | 300 | 130 | 335 |
| Comparative | 254 | 66 | 100 | 300 | 130 | 335 |
| Example 4 | | | | | | |

| Wa | Wb | Wc | Wd | W1 | W2 |
|---|---|---|---|---|---|
| (μm) | (μm) | (μm) | (μm) | (μm) | (μm) |
| 35 | 25 | 15 | 10 | 30 | 30 |
| 35 | 25 | 15 | 10 | 30 | 30 |
| 35 | 25 | 15 | 10 | 30 | 30 |
| 35 | 25 | 15 | 10 | 37 | 28 |
| 35 | 25 | 15 | 10 | 23 | 32 |

The other conditions were as follows.

The electronic component was 0.4 mm in length (dimension in the front-rear direction) and 0.2 mm in width (dimension in the right-left direction). The multilayer body was 0.37 mm in length (dimension in the front-rear direction) and 0.18 mm in width (dimension in the right-left direction). The relative magnetic permeability of the insulating layers was 180. The dielectric constant of the insulating layers was 15. The thickness of each of the insulating layers was 3 μm. The electrical conductivity of the Ag-based conductors was 6.289×10⁷ (S/m). The thickness of each of the coil conductors and the lead conductors was 5 μm. The length (dimension in the up-down direction) of each of the via-hole conductors was 3 μm. The thickness of the outer layer of the multilayer body was 25 μm. The thickness of the outer layer of the multilayer body means the total of the thicknesses of the insulating layers 16a-16c (or the insulating layers 16g-16j).

With regard to each of the samples fabricated as described above, the inductance value (μH), the impedance value (Ω) when transmitting a signal of 100 MHz, DC resistance value (Ω), the acquisition efficiency and the height (dimension in the up-down direction) of the electronic component (μm) were measured and calculated. Table 2 indicates the measurement results and the calculation results. The acquisition efficiency is a value obtained by dividing the impedance value by the DC resistance value. For accurate comparison of the samples according to the first through fourth comparative examples and the first embodiment with one another, the samples were fabricated to have substantially the same inductance value and substantially the same impedance value.

TABLE 2

| | Inductance (Ω) | Impedance (Ω) | DC Resistance (Ω) |
|---|---|---|---|
| Comparative | 0.373 | 121 | 0.364 |
| Example 1 | | | |
| Comparative | 0.356 | 116 | 0.248 |
| Example 2 | | | |
| Comparative | 0.373 | 121 | 0.261 |
| Example 3 | | | |
| Embodiment 1 | 0.372 | 121 | 0.254 |
| Comparative | 0.373 | 121 | 0.278 |
| Example 4 | | | |

| Acquisition Efficiency | Height (μm) |
|---|---|
| 332 | 130 |
| 468 | 274 |
| 464 | 130 |
| 475 | 130 |
| 437 | 130 |

The sample according to the first comparative example had a relatively high DC resistance value of 0.364Ω. As compared to this sample, the sample according to the second comparative example including a pair of coil conductors 118a, a pair of coil conductors 118b, a pair of coil conductors 118c and a pair of coil conductors 118d, the conductors in each pair being connected in parallel to each other by via-hole conductors, had a lower DC resistance value (0.248Ω). Meanwhile, since the sample according to the second comparative example included a larger number of coil conductors 118a-118d stacked on one another than the sample according to the first comparative example, the sample according to the second comparative example had a greater height (274 μm) than the sample according to the first comparative example (130 μm). On the other hand, the DC resistance value of the sample according to the first embodiment was 0.254Ω, which was considerably lower than the DC resistance value of the sample according to the first comparative example (0.364Ω) and relatively near the DC resistance value of the sample according to the second comparative example (0.248Ω). The height of the sample according to the first embodiment was 130 μm, which was lower than the height of the sample according to the second comparative example (274 μm) and equal to the height of the sample according to the first comparative example (130 μm). Thus, the sample according to the first embodiment had a reduced DC resistance value and a reduced height. In the sample according to the first embodiment, the widths W1 of the portions of the coil conductors 18a-18d extending along the front and rear shorter sides are greater than the widths W2 of the portions of the coil conductors 18a-18d extending along the right and left longer sides. In the sample according to the third comparative example, on the other hand, the widths W2 of the portions of the coil conductors 18a-18d extending along the right and left longer sides are equal to the widths W1 of the portions of the coil conductors 18a-18d extending along the front and rear shorter sides. In the sample according to the fourth comparative example, the widths W2 of the portions of the coil conductors 18a-18d extending along the right and left longer sides are greater than the widths W1 of the portions of the coil conductors 18a-18d extending along the front and rear shorter sides. Now, the DC resistance values of the sample according to the third comparative example, the sample according to the fourth comparative example and the sample according to the first embodiment are compared to each other. The DC resistance value of the sample according to the first embodiment was 0.254Ω, which was lower than either of the DC resistance value of the sample according to the third comparative example (0.261Ω) and the DC resistance value of the sample according to the fourth comparative example (0.278Ω), and accordingly, the acquisition efficiency of the sample according to the first embodiment was high.

As a reference against the sample according to the third comparative example in which the widths W2 of the portions of the coil conductors 18a-18d extending along the right and left longer sides are equal to the widths of the portions of the coil conductors 18a-18d extending along the front and rear shorter sides (W1=W2=30 μm), a sample in which the widths W1 of the portions of the coil conductors 18a-18d extending along the front and rear shorter sides are increased from 30 μm to 40 μm was prepared. This sample will hereinafter be referred to as a sample according to a second embodiment. Further, in contrast to the second embodiment, a sample in which the widths W2 of the portions of the coil conductors 18a-18d extending along the right and left longer sides are increased from 30 μm to 40 μm was prepared. This sample will hereinafter be referred to as a sample according to a fifth comparative example.

TABLE 3

| | L1 | L2 | L3 | L4 | L5 | L6 |
|---|---|---|---|---|---|---|
| | (μm) | (μm) | (μm) | (μm) | (μm) | (μm) |
| Comparative | 240 | 70 | 100 | 300 | 130 | 335 |
| Example 3 | | | | | | |
| Embodiment 2 | 220 | 70 | 100 | 300 | 130 | 335 |
| Comparative | 240 | 50 | 100 | 300 | 130 | 335 |
| Example 5 | | | | | | |

| Wa | Wb | Wc | Wd | W1 | W2 |
|---|---|---|---|---|---|
| (μm) | (μm) | (μm) | (μm) | (μm) | (μm) |
| 35 | 25 | 15 | 10 | 30 | 30 |
| 35 | 25 | 15 | 10 | 40 | 30 |
| 35 | 25 | 15 | 10 | 30 | 40 |

With regard to each of these samples also, the inductance value (μH), the impedance value (Ω) while transmitting a signal of 100 MHz, the DC resistance value (Ω), the acquisition efficiency and the height (dimension in the up-down direction) of the electronic component (μm) were measured and calculated. Table 4 indicates the measurement results and the calculation results.

TABLE 4

| | Inductance (Ω) | Impedance (Ω) | DC Resistance (Ω) |
|---|---|---|---|
| Comparative | 0.373 | 121 | 0.261 |
| Example 3 | | | |
| Embodiment 2 | 0.342 | 111 | 0.234 |
| Comparative | 0.267 | 87 | 0.209 |
| Example 5 | | | |

| Acquisition Efficiency | Height (μm) |
|---|---|
| 464 | 130 |
| 476 | 130 |
| 416 | 130 |

In the sample according to the third comparative example, the square measure S of the inside of the coil L was 16800 μm. In the sample according to the second embodiment, the square measure S of the inside of the coil L was 15400 μm, and as compared to the sample according to the third comparative example, the rate of decrease in the square measure S was about 8%. However, in the sample according to the fifth comparative example, the square measure S of the inside of the coil L was 12000 μm, and as compared to the sample according to the third comparative example, the rate of decrease in the square measure S was about 28%, which was significantly large. Accordingly, the rate of decrease in the inductance value of the sample according to the second embodiment as compared to the third comparative example was smaller than the rate of decrease in the inductance value of the sample according to the fifth comparative example as compared to the third comparative example. Therefore, in the electronic component 10a, a decrease in the inductance value can be reduced.

### First Modification

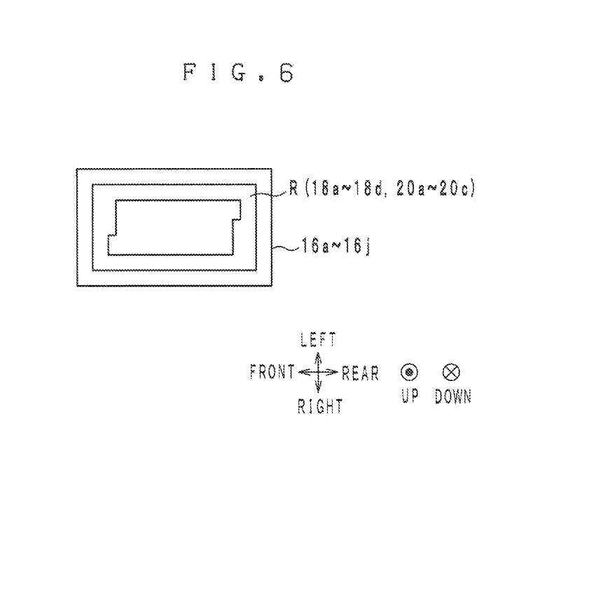

An electronic component 10b according to a first modification will hereinafter be described with reference to the drawings. FIG. 4 is an exploded perspective view of the multilayer body 12 of the electronic component 10b according to the first modification. FIG. 6 is a plan view of the coil conductors 18a-18d and the parallel conductors 20a-20c arranged to overlap one another. The appearance of the electronic component 10b is as illustrated in FIG. 1.

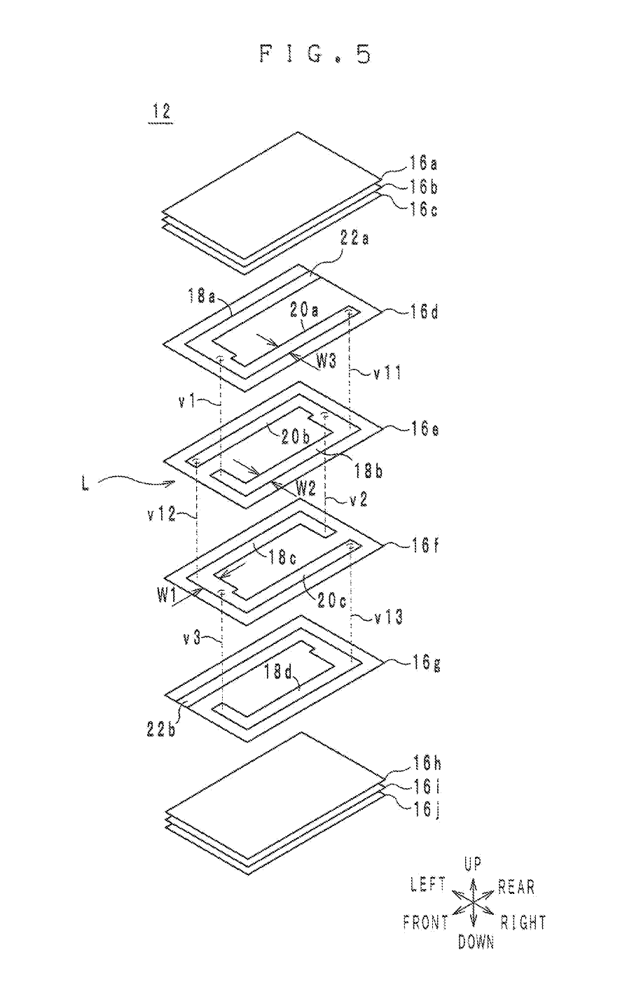

The electronic component 10b is different from the electronic component 10a in the shapes of the coil conductors 18a-18d and the parallel conductors 20a-20c. More specifically, as seen in FIG. 5, the coil conductor 18a has a length corresponding to a three-eighths turn. The portion of the coil conductor 18a extending along the left half of the front shorter side of the insulating layer 16d has a greater width than any other portion of the coil conductor 18a.

Each of the coil conductors 18b and 18c has a length corresponding to a half turn. The coil conductor 18b extends along the right half of the front shorter side, the right longer side and the right half of the rear shorter side of the insulating layer 16e. The coil conductor 18c extends along the left half of the rear shorter side, the left longer side and the left half of the front shorter side of the insulating layer 16f.

The coil conductor 18d has a length corresponding to a seven-eighths turn. The conductor 18d extends along the right half of the front shorter side, the right longer side, the rear shorter side and the left longer side of the insulating layer 16g.

Each of the parallel conductors 20a-20c has a length corresponding to a three-eighths turn. The parallel conductor 20a extends along the right half of the front shorter side and the right longer side of the insulating layer 16d. The parallel conductor 20b extends along the left half of the rear shorter side and the left longer side of the insulating layer 16e. The parallel conductor 20c extends along the right half of the front shorter side and the right longer side of the insulating layer 16f.

The via-hole conductors v1-v3 and v11-v13 of the electronic component 10b are the same as the via-hole conductors v1-v3 and v11-v13 of the electronic component 10a, and a description thereof is omitted.

The portions of the coil conductors 18b-18d that are not connected in parallel to any of the parallel conductors 20a-20c have a width W1, and the portions of the coil conductors 18b-18d that are connected in parallel to any of the parallel conductors 20a-20c have a width W2. The width W1 is greater than the width W2. The coil conductors 18b-18d and the parallel conductors 20a-20c of the electronic component 10b differ in shape from the coil conductors 18b-18d and the parallel conductors 20a-20c of the electronic component 10a. Specifically, the portion of the coil conductor 18b extending along the right half of the rear shorter side of the insulating layer 16e has a greater width than any other portion of the coil conductor 18b. The portion of the coil conductor 18c extending along the left half of the front shorter side of the insulating layer 16f has a greater width than any other portion of the coil conductor 18c. The portion of the coil conductor 18d extending along the right half of the rear shorter side of the insulating layer 16g has a greater width than any other portion of the coil conductor 18d. Accordingly, as seen in FIG. 6, the widths of the portions of the coil conductors 18a-18d forming the left half of the front shorter side of the path R and the portions of the coil conductors 18a-18d forming the right half of the rear shorter side of the path R are greater than the widths of any other portions of the coil conductors 18a-18d and the parallel conductors 20a-20c forming any other portion of the path R.

By virtue of having the above-described structure, as is the case with the electronic component 10a, the electronic component 10b has a reduced height (a reduced dimension in the up-down direction) and a reduced DC resistance value of the coil L. Also, in the electronic component 10b, as is the case with the electronic component 10a, the decrease in the inner diameter of the coil L accompanied with the reduction in the DC resistance value of the coil L can be reduced.

Further, the wider portions of the coil L of the electronic device 10b are shorter than the wider portions of the coil L of the electronic component 10a. Therefore, the inner diameter of the coil L of the electronic component 10b is greater than the inner diameter of the coil L of the electronic component 10a. Accordingly, the inductance value of the coil L of the electronic component 10b is greater than the inductance value of the coil L of the electronic component 10a.

### Second Modification

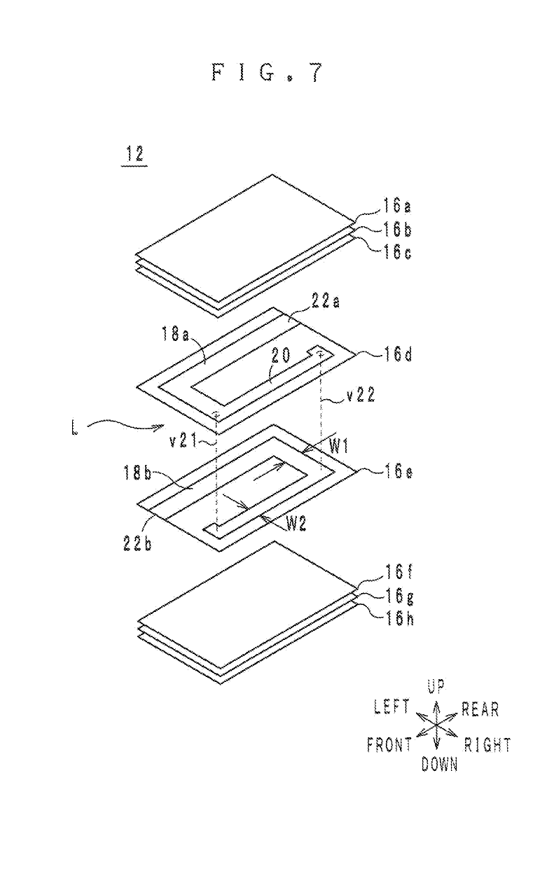

An electronic component 10c according to a second modification will hereinafter be described with reference to the drawings. FIG. 7 is an exploded perspective view of the multilayer body 12 of the electronic component 10c according to the second modification. The appearance of the electronic component 10c is as illustrated in FIG. 1.

The electronic component 10c differs from the electronic component 10a in the structure of the coil L. More specifically, the coil L of the electronic component 10c includes coil conductors 18a, 18b, lead conductors 22a, 22b, and a via-hole conductor v21.

The coil conductor 18a is a linear conductor turning counterclockwise on the front surface of the insulating layer 16d. The coil conductor 18a has a length corresponding to a half turn and extends along the left longer side and the front shorter side of the insulating layer 16d.

The coil conductor 18b is a linear conductor turning counterclockwise on the front surface of the insulating layer 16e. The coil conductor 18b has a length corresponding to a three-quarter turn and extends along the right longer side, the rear shorter side and the left longer side of the insulating layer 16e.

The coil conductors 18a and 18b structured above are arranged to overlap each other to form a rectangular path along the outer edges of the insulating layers 16a-16h in a planar view from the upside. The coil conductors 18a and 18b are made of a conductive material, for example, an Ag-based material. In the following paragraphs, the upstream edge of the counterclockwise turn of each of the coil conductors 18a and 18b will be referred to as an upstream edge, and the downstream edge of the counterclockwise turn of each of the coil conductors 18a and 18b will be referred to as a downstream edge.

The via-hole conductor v21 pierces through the insulating layer 16d vertically so as to connect the downstream edge of the coil conductor 18a to the upstream edge of the coil conductor 18b. Accordingly, the coil L is formed into a spiral shape extending downward while turning counterclockwise.

A parallel conductor 20 is provided on the front surface of the insulating layer 16d on which the coil conductor 18a is provided. The parallel conductor 20 is a linear conductor extending along the right longer side of the insulating layer 16d. The parallel conductor 20 is connected to the downstream edge of the coil conductor 18a. Thus, the coil conductor 18a and the parallel conductor 20 that are provided on the same surface of the insulating layer 16d are connected to each other. When viewed from the upside, the parallel conductor 20 overlaps the portion of the coil conductor 18b extending along the right longer side of the insulating layer 16e.

A via-hole conductor v22 pierces through the insulating layer 16d vertically so as to connect the rear edge of the parallel conductor 20 to the right rear corner of the coil conductor 18b. Thus, the parallel conductor 20 is connected in parallel to the coil conductor 18b, which is provided on the front surface of the insulating layer 16e different from the insulating layer 16d on which the parallel conductor 20 is provided, through the via-hole conductors v21 and v22.

The portion of the coil conductor 18b that is not connected in parallel to the parallel conductor 20 has a width W1, and the portion of the coil conductor 18b that is connected in parallel to the parallel conductor 20, excluding the contact points with the via-hole conductors v21 and v22, has a width W2. The width W1 is greater than the width W2. More specifically, the parallel conductor 20 is connected in parallel to the portion of the coil conductor 18b extending along the right longer side of the insulating layer 16e. Accordingly, the width W1 of the portion of the coil conductor 18b extending along the rear shorter side of the insulating layer 16e is greater than the width W2 of the portion of the coil conductor 18b extending along the right longer side of the insulating layer 16e.

The coil conductor 18b and the parallel conductor 20 are connected to each other through the via-hole conductors v21 and v22. In order to secure the contact of the coil conductor 18b with the via-hole conductors v21 and v22, the portions of the coil conductor 18b around the contact points with the via-hole conductors v21 and v22 are widened. Thus, both ends of the portion of the coil conductor 18b extending along the right longer side of the insulating layer 16e have an increased width as compared to any other part of the same portion of the coil conductor 18b.

By virtue of having the above-described structure, as is the case with the electronic component 10a, the electronic component 10c has a reduced DC resistance value of the coil L and a reduced height (a reduced dimension in the up-down direction). Also, in the electronic component 10c, as is the case with the electronic component 10a, the decrease in the inner diameter of the coil L accompanied with the reduction in the DC resistance value of the coil L can be reduced.

### Other Embodiments

Electronic components according to the present disclosure are not limited to the electronic components 10a-10c described above, and various changes and modifications are possible within the scope of the disclosure.

In each of the electronic components 10a and 10b, it is only necessary that the portions of the coil conductors 18b-18d that are not connected to any of the parallel conductors 20a-20c at least partly have the greater width W1 than the width W2 of the portions of the coil conductors 18b-18d that are connected to any of the parallel conductors 20a-20c. In the electronic component 10c, it is only necessary that the portion of the coil conductor 18b that is not connected to the parallel conductor 20 at least partly has the greater width W1 than the width W2 of the portion of the coil conductor 18b that is connected to the parallel conductor 20 other than the contact points with the via-hole conductors v21 and v22.

The external electrodes 14a and 14b of each of the electronic components 10a, 10b and 10c cover the rear end surface and the front end surface, respectively, of the multilayer body 12, and are extended to partly cover the four surfaces adjoining the front end surface and the rear end surface. However, the external electrodes 14a and 14b may cover the upper surface and the lower surface, respectively, of the multilayer body 12, and may be extended to partly cover the four surfaces adjoining to the upper surface and the lower surface. In this case, the external electrodes may be connected to the coil conductors not by the lead conductors 22a and 22b but by via-hole conductors piercing vertically through the insulating layers 16a-16c and 16h-16j.

In each of the electronic components 10a and 10b, the parallel conductors 20a-20c need not necessarily be connected to the coil conductors 18a-18c, respectively. In the electronic component 10c, the parallel conductor 20 needs not necessarily be connected to the coil conductor 18a. Instead, by forming via-hole conductors piercing through the insulating layers 16d-16f, the coil conductors can be connected in parallel to the respective parallel conductors.

In the description above, the path R is defined to have a rectangle shape. The “rectangle” means not only a quadrangle having right-angled corners but also a quadrangle having rounded-off corners. The “rectangle” also includes a track-like shape having two long sides and two circular arcs connecting the ends of the long sides to each other. In this case, the circular arcs correspond to the shorter sides.

### INDUSTRIAL APPLICABILITY

As thus far described, the present disclosure is useful to electronic components. The present disclosure has an advantage especially in reducing the height (dimension in a stacking direction) while reducing the DC resistance value.

What is claimed is:

1. An electronic component comprising:
a multilayer body including a plurality of insulating layers stacked on one another in a stacking direction;
a spiral coil including a plurality of coil conductors provided on the insulating layers and a first via-hole conductor piercing through at least one of the insulating layers in the stacking direction to connect the plurality of coil conductors to each other;
a parallel conductor provided on one of the insulating layers on which the coil conductors are provided; and
a second via-hole conductor piercing through at least one of the insulating layers in the stacking direction to connect the parallel conductor in parallel to one of the coil conductors provided on the insulating layer different from the insulating layer on which the parallel conductor is provided, wherein:
a portion of the coil conductor not connected in parallel to the parallel conductor at least partly has a greater width than a portion of the coil conductor connected in parallel to the parallel conductor other than a contact point with the second via-hole conductor.

2. The electronic component according to claim 1, wherein:
the parallel conductor is connected to the coil conductor provided on the same insulating layer; and
the parallel conductor is connected in parallel to the coil conductor provided on one of the insulating layers different from the insulating layer on which the parallel conductor is provided by the first via-hole conductor and the second via-hole conductor.

3. The electronic component according to claim 2, wherein the portion of the coil conductor not connected in parallel to the parallel conductor at least partly has a greater width than a portion of the coil conductor connected in parallel to the parallel conductor other than the contact point with the first via-hole conductor and a contact point with the second via-hole conductor.

4. The electronic component according to claim 1, wherein:
the insulating layers are rectangular;
the coil conductors are arranged to overlap one another to form a rectangular path along outer edges of the insulating layers when viewed from the stacking direction; and
widths of portions of the coil conductors corresponding to a shorter side of the rectangular path are greater than widths of portions of the coil conductors corresponding to a longer side of the rectangular path.

5. The electronic component according to claim 1, wherein:
the insulating layers are rectangular;
the coil conductors are arranged to overlap one another to form a rectangular path along outer edges of the insulating layers when viewed from the stacking direction; and
the parallel conductor is connected in parallel to a portion of the coil conductor forming a longer side of the rectangular path.
